(19) United States
(12) Patent Application Publication
(10) Pub. No.: US 2019/0238485 A1
(43) Pub. Date: Aug. 1, 2019

(54) TRANSMITTING CREDITS BETWEEN ACCOUNTING CHANNELS

(71) Applicant: Hewlett Packard Enterprise Development LP, Houston, TX (US)

(72) Inventor: Jonathan M. Seely, Roseville, CA (US)

(21) Appl. No.: 15/884,039

(22) Filed: Jan. 30, 2018

(51) Int. Cl. H04L 12/861; H04L 12/947

(52) U.S. Cl. CPC H04L 49/9047; H04L 49/25

(57) ABSTRACT

Example implementations relate to transmitting credits between accounting channels. A first number of credits may be transmitted to a source accounting buffer over a first accounting channel that is inactive. A second accounting channel may be inactivated and the first accounting channel may be activated. Any remaining credits received via the second accounting channel may be transmitted from the source accounting buffer to a destination accounting buffer.

### BACKGROUND

Data may be transferred between nodes of a computing network, i.e. a collection of devices in communication with each other over a common communication protocol or transport. Specifically, data in the form of packet flows may be transferred between devices such as a source node and a destination node in a network.

A network device may include a control processor, a switch fabric, and/or a line card. The control processor may implement control and/or administrative functions, and may execute routing protocols. A line card may implement protocol processing functions within the network, while the switch fabric may facilitate the transfer of packets between nodes.

### BRIEF DESCRIPTION OF THE DRAWINGS

Certain examples are described in the following detailed description and in reference to the drawings, in which:

FIG. 1 is a block diagram illustrating an example system for reclaiming credits of a destination node.

FIG. 2 is a flowchart illustrating a method for reclaiming credits of a destination node.

FIG. 3 is a flowchart illustrating a method for reclaiming credits of a destination node.

FIG. 4 is a block diagram of an example non-transitory machine-readable mediums for switching the activation of accounting channels to reclaim lost credits.

FIG. 5 is a block diagram of an example non-transitory machine-readable medium for switching the activation of accounting channels to reclaim lost credits.

### DETAILED DESCRIPTION OF SPECIFIC EXAMPLES

Nodes within a network may exchange data. Specifically, nodes may be connected via a shared interface and may transmit packets to each other through data link channels between the nodes. The data link may employ a variety of link layer technologies for transferring data such as, for example, an Ethernet link layer technology. The data link may also include an interconnect fabric including any number of wired and/or wireless data link connecting nodes. In some example implementations, portions of the interconnect fabric of the network may be contained within and/or connected to a network switch.

As described above, the network switch, which may include an Ethernet network switch, may facilitate the routing of packets between nodes. The network switch may receive, process, and forward data from a source node to a destination node across the interconnect fabric. To facilitate the receipt of multiple data packets, a destination node may include a memory buffer for storing received data packets prior to processing. A memory buffer however, may store a finite amount of data.

Since the memory buffer of the destination node may store a finite amount of data, and the memory buffer may otherwise have a finite capacity to process data, the destination node may receive more data than the destination node can process, and/or store at any given time. Where more data is received by the destination node than the destination node is able to process or store, networking errors may occur, data may be lost, data flows may be interrupted, etc. Various amounts of space within a memory buffer may be allocated to each source node to ensure there is enough space within the memory buffer at any given time to receive incoming data.

In an example implementation, a destination node may have a destination accounting buffer for tracking credits available to the destination node to allocate to source nodes. A credit may define a unit size of data available to a source node to transmit to the destination node. As determined by the availability of credits within a credit pool of a destination accounting buffer, a destination node may allocate credits to any number of source nodes such that the destination node does not receive a larger amount of data than the destination node can store and/or process.

Credits can be transmitted from the destination accounting buffer to a source accounting buffer of a source node. The credits may be transmitted over an accounting channel. For example, the destination accounting buffer may initially transmit twenty credits to a source accounting buffer over an accounting channel. The source may transmit five credits worth of data to the destination node, and the source accounting buffer may concurrently send five credits back to the destination accounting buffer. After a predetermined period of time, and/or after the data transmitted by the source node is resolved at the destination node, the destination accounting node may determine an amount of credits to send back to the source accounting buffer. Thus, credits may be utilized as a means to control the transfer of data from a source node to a destination node.

Data packets transmitted over a network may be corrupted, dropped, or otherwise lost. Consequently, credits may be lost and are also otherwise susceptible to corruption. Given a closed loop system where credits are transferred between the source accounting buffers of source nodes and the destination accounting buffer of a destination node, the loss of credits may result in a resource leak, such that destination node resources are underutilized.

Examples of the present disclosure may include, systems, methods, and machine-readable media for reclaiming lost credits by utilizing a plurality of accounting channels. Specifically, a first number of credits may be transmitted to a source accounting buffer over an inactive first accounting channel for transmitting credits between the source accounting buffer and the destination accounting buffer. A second accounting channel for transmitting credits between the source accounting buffer and the destination accounting buffer may be inactivated, and the first accounting channel may be activated. Any remaining credits received are transmitted via the second accounting channel from the source accounting buffer to the destination accounting buffer.

In the description below, components may be referenced by specific numbers, e.g. first source node, second accounting channel, etc. These reference numbers are example numbers for explanation purposes and do not imply a particular order, nor do they connote any significance other than to reference particular nodes described.

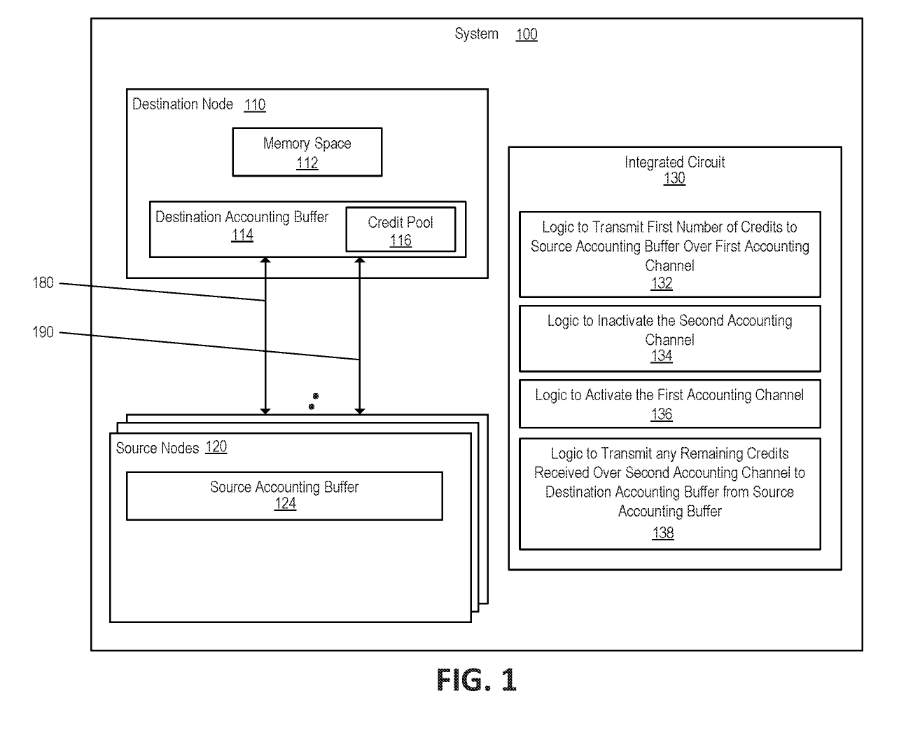

FIG. 1 is a block diagram illustrating an example system 100 for reclaiming credits of a destination node. System 100 may include a destination node 110 having a memory space 112, i.e. for storing received data before it is resolved, and a destination accounting buffer 114 for tracking credits available to transmit to any number of source nodes. Destination accounting buffer 114 may include credit pool 116. Credits within credit pool 116 may be freely assignable by destination accounting buffer 114 to other source nodes of source nodes 120. Destination node may be implemented as hardware or any combination of hardware and software/firmware. Source nodes 120 and destination node 110 may transmit credits over a first accounting channel 180 and a second accounting channel 190. First accounting channel 180 and/or second accounting channel 190 may be any electronic communication device facilitating the transportation of data, e.g. credits, packets, etc., between nodes. Each source node of source nodes 120 may include a source accounting buffer 124. Source nodes 120 may be implemented as hardware or any combination of hardware and software/firmware. Credits may be transmitted between destination accounting buffer 114 and any source accounting buffers 124 via first accounting channel 180 and/or second accounting channel 190.

For example, destination accounting buffer 114 may track an initial allocation of one hundred credits. Destination accounting buffer 114 may further allocate twenty credits to a first source node of source nodes 120 and thirty credits to a second source node of source nodes 120, whereby destination accounting buffer retains fifty credits for future transmission within credit pool 116. Specifically, destination accounting buffer 114 may transmit twenty credits to the first source node via an active accounting channel. Source accounting buffer of first source node tracks the twenty credits first source node is allocated and source accounting buffer of second source node tracks the thirty credits second source node is allocated.

First source node of source nodes 120 may transmit five credits worth of data to destination node 110, and the source accounting buffer of the first source node may concurrently transmit five credits to destination accounting buffer 114, after which destination accounting buffer may retain fifty-five credits for transmission. After a predetermined time or event, e.g. after the five credits worth of data transmitted to the first source node is resolved and/or otherwise removed from memory space 112, destination accounting buffer 114 may retransmit the five credits, or any other amount of credits, back to the source accounting buffer of the first source node via an active accounting channel.

System 100 may further include integrated circuit 130. Integrated circuit 130 may exist on any number of physical electronic devices, such as a line card or any other modular electronic circuit designed to interface with a network. Integrated circuit 130 exists may implement logic 132-138 as a protocol. Logic 132-138 may otherwise be implemented as dedicated electronic circuitry including a field-programmable gate array and/or any number of application-specific integrated circuits (ASICs) within an electronic device such as a line card, fixed configuration switch, etc. Any combination of logic 132-138 may, for example, be implemented as an integrated circuit in source node 120, source accounting buffer 124, destination node 110, destination accounting buffer 114, etc. In some example implementations, any combination of logic 132-138 may be implemented in a file server.

In this example, prior to the implementation of logic 132-138, first accounting channel 180 is inactive and second accounting channel 190 is active. Logic 132, when implemented, may transmit a first number of credits to source accounting buffer 124 over first accounting channel 180. In some example implementations, the number of credits transmitted to source accounting buffer 124 may be equal to a first number of credits allocated to a first source node of sources node 120 over active second accounting channel 190. For instance, prior to transmitting the first number of credits to source accounting buffer 124, the first number of credits may be copied from the credits allocated to the first source node of source nodes 120 over second accounting channel 190 to first accounting channel 180.

As an example, twenty credits may be allocated over active second accounting channel. Those twenty credits may be copied and transmitted to source accounting buffer 124 over inactive first accounting channel 180. Thus, at a given time, source node may be allocated twenty credits over active second accounting channel and another twenty credits over inactive first accounting channel.

To facilitate the transition between accounting channels, active channels may be inactivated and inactive channels may be activated. Logic 134, when implemented, may inactivate second accounting channel 190. Similarly, logic 136, when implemented, may activate first accounting channel 180. In an example, the first source node of source nodes 120 may switch the active status of the channels in response to an event, such as a received message, and/or a receipt of credits over inactive first accounting channel 180. In response, first source node of source nodes 120 may activate first accounting channel 180 and may inactivate second accounting channel 190.

As the active channel, first accounting channel may facilitate the transmittal of credits from destination accounting buffer 114 to source accounting buffer 124. Thus, when destination node 110 allocates further credit to the first source node of source nodes 120, it will do so over the newly activated channel, in this case activated accounting channel 180. Similarly, credits may be transmitted over the active channel and not the inactive channel when tracking the transmission of data from the first source node of source nodes 120 to destination node 110.

Logic 138, when implemented, may transmit any remaining credits received over second accounting channel 190 to destination accounting buffer 114 to be reclaimed. Thus, following the example illustrated above, the source node may return the twenty credits the source node was allocated over inactive second accounting channel 190 to destination accounting buffer 114. In some examples, the transmitted remaining credits may be added to credit pool 116 of destination accounting buffer 114, the credits in credit pool 116 transmittable to any of source nodes 120.

In some example implementations, second accounting channel 190 may have unresolved data transmissions initiated prior to second accounting channel 190 being inactivated. To ensure credits associated with the unresolved data transmissions are accounted for, the logic may facilitate the passing of a predetermined period of time between the inactivation of second accounting channel 190 and the transmission of any remaining credits from second accounting channel 190 to destination accounting buffer 114.

In an example, the period of time may be predetermined based on the network fabric. For example, a longest period of time for transmission data to settle may be determined from network parameters such as a network bandwidth, potential congestion within the network, node resources, etc. The period of time may be dynamically adjusted based on network conditions, and in some example implementations, may vary according to determined network congestion. For instance, higher than average network congestion may result in a longer period of time for data transmissions to resolve and thus may result in a longer generated waiting period.

By switching active channels from second accounting channel 190 to first accounting channel 180, lost credits may be reclaimed. For example, the number of credits initially allocated to a first source node of source nodes 120 via second accounting channel 190 may be compared to the number of the remaining credits transmitted from second accounting channel 190 to destination accounting buffer 114. The difference between the initial number of credits allocated to the number of remaining credits transmitted may equal the number of lost credits. To reclaim the number of credits lost, a number of credits may be added to the credit pool equal to the difference between the number of credits initially allocated to the source node over the second accounting channel and the number of remaining credits transmitted.

In an example, the process of switching active and inactive channels may be periodic and may occur after a predetermined event or after a predetermined period of time. The predetermined event may be a number of credits transmitted or received by destination accounting buffer 114 or any other event related to the transmission of credits between a destination node and a source node. The predetermined period of time may be, a predetermined period of time for which credits have not been added to the credit pool of destination accounting buffer 114, a predetermined time since credits were initially allocated by destination node 110 to a source node of source nodes 120, a predetermined time since first accounting channel 180 and/or second accounting channel 190 had been activated and/or inactivated, a combination thereof, and/or any other time related to the transmission of credits between a destination node and a source node.

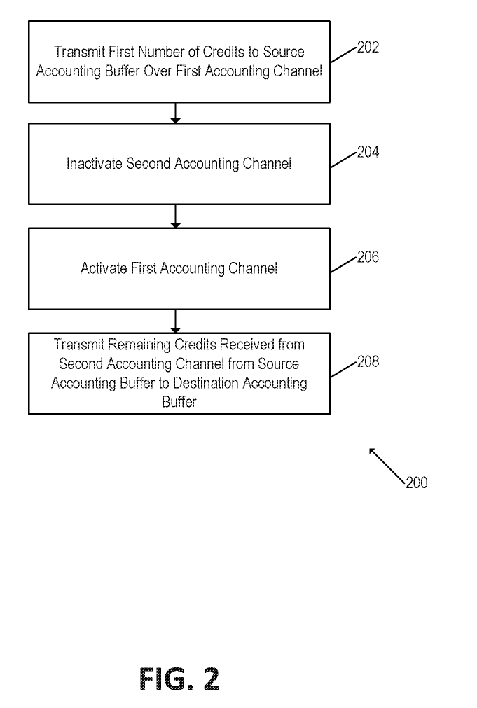

FIG. 2 is a flowchart illustrating a method 200 for reclaiming credits of a destination node. Although execution of method 200 is described below with reference to system 100, this is for explanatory purposes and other suitable components for execution of method 100 may be utilized. Additionally, the components for executing method 200 may spread among multiple devices. Method 200 may be implemented in the form of executable instructions stored on a machine-readable storage medium and/or in the form of electronic circuitry, e.g. hardware. In some examples, steps of method 200 may be executed substantially concurrently or in a different order than shown in FIG. 2. In some examples, method 200 may include more or less steps than are shown in FIG. 2. In some examples, some of the steps of method 200 may, at certain times, be ongoing and/or may repeat.

At block 202, a first number of credits may be transmitted to a source accounting buffer over a first accounting channel. For example, the number of credits transmitted to source accounting buffer 124 may be equal to a first number of credits allocated to a first source node of sources node 120 over active second accounting channel 190. To facilitate the transition between accounting channels, active channels may be inactivated and inactive channels may be activated. At block 204, second accounting channel 190 may be inactivated. Similarly, at block 206 first accounting channel 180 may be activated. In an example, the active status of the channels may be switched in response to an event, such as a received message, and/or a receipt of credits over inactive first accounting channel 180.

As the active channel, first accounting channel may now facilitate the transmittal of credits from destination accounting buffer 114 to source accounting buffer 124. Thus, when destination node 110 allocates further credit to the first source node of source nodes 120, it will do so over the newly activated channel. Similarly, credits may be transmitted over the active channel and not the inactive channel when tracking the transmission of data from the first source node of source nodes 120 to destination node 110.

At block 208, any remaining credits received over second accounting channel 190 from source accounting buffer 124 may be transmitted to destination accounting buffer 114. Thus, any credits initially allocated to inactive second accounting channel 190 may be returned to destination accounting buffer 114. In some example implementations, second accounting channel 190 may have unresolved data transmissions initiated prior to second accounting channel 190 being inactivated. To ensure credits associated with the unresolved data transmissions are accounted for, the logic may facilitate the passing of a predetermined period of time between the inactivation of second accounting channel 190 and the transmission of any remaining credits from second accounting channel 190 to destination accounting buffer 114. Accordingly, credits initially allocated via second accounting channel 190 may be reclaimed.

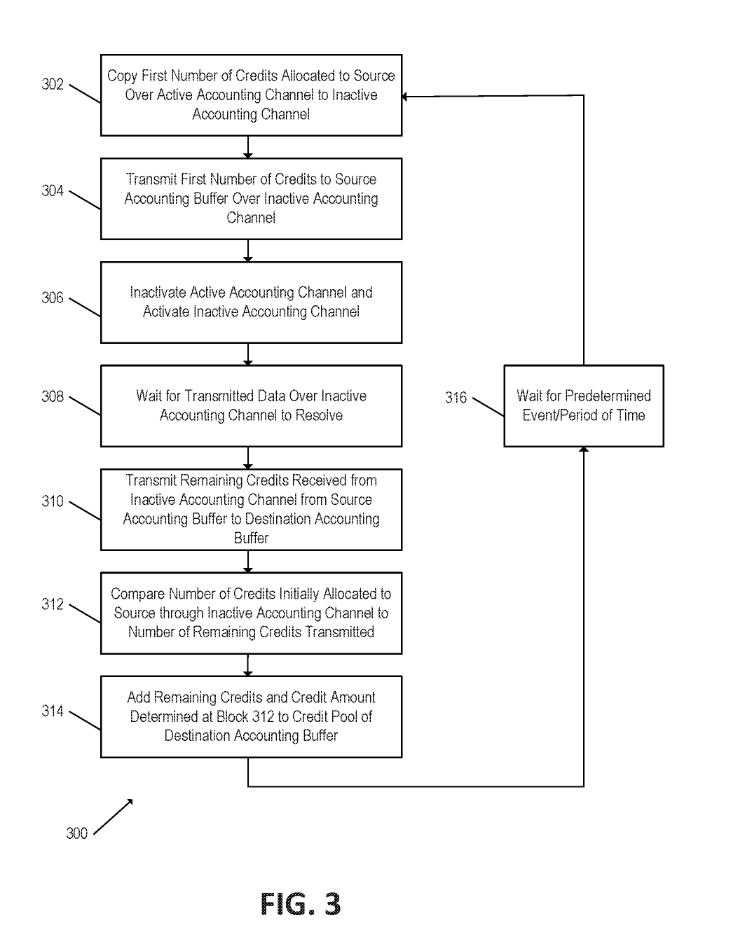

FIG. 3 is a flowchart illustrating a method 300 for reclaiming credits of a destination node. Although execution of method 300 is described below with reference to system 100, this is for explanatory purposes and other suitable components for execution of method 100 may be utilized. Additionally, the components for executing method 300 may spread among multiple devices. Method 300 may be implemented in the form of executable instructions stored on a machine-readable storage medium and/or in the form of electronic circuitry, e.g. hardware. In some examples, steps of method 300 may be executed substantially concurrently or in a different order than shown in FIG. 3. In some examples, method 300 may include more or less steps than are shown in FIG. 3. In some examples, some of the steps of method 300 may, at certain times, be ongoing and/or may repeat.

At block 302, a first number of credits allocated to a source node over an active accounting channel may be copied to an inactive accounting channel. For instance, the first number of credits may be copied from the active channel to the inactive channel, e.g. either channel 180 or channel 190, depending on which channel is currently active and which channel is currently inactive. At block 304, the first number of credits may be transmitted to source accounting buffer 124 over the inactive accounting channel.

As an example, twenty credits may be allocated over active second accounting channel 190. The twenty credits allocated over active second accounting channel 190 may be copied to inactive first accounting channel 180 and transmitted to source accounting buffer 124 over inactive first accounting channel 180. Thus, at a given time a source node of source nodes 120 may be allocated a first number of credits over the active accounting channel and an equal number of credits may be allocated over the inactive accounting channel.

To facilitate the transition between accounting channels, active channels may be inactivated and inactive channels may be activated. At block 306, an active accounting channel may be inactivated and an inactive accounting channel may be activated. In an example, the first source node of source nodes 120 may switch the active status of the channels in response to an event, such as a received message, and/or a receipt of credits over the inactive accounting channel 180. The newly activated channel may facilitate the transmittal of credits from destination accounting buffer 114 to source accounting buffer 124. Thus, when destination node 110 allocates further credit to the first source node of source nodes 120, it will do so over the activated channel.

In some example implementations, the inactivated channel may have unresolved data transmissions initiated prior to the accounting channel being inactivated. At block 308, the system may wait a predetermined period of time for the transmitted data over the inactivated accounting channel to resolve. In an example, the time to resolve may be the time between the inactivation of the active channel and the transmission of any remaining credits from the inactivated channel to destination accounting buffer 114.

At block 310, any remaining credits received via the inactivated accounting channel may be transmitted from source accounting buffer 124 to destination accounting buffer 114. For example, twenty credits allocated to a previously active accounting channel may be returned to destination accounting buffer 114 after the accounting channel is inactivated and/or after the predetermined period of time subsequent to inactivation.

By switching an active channel to inactive and an inactive channel to active, lost credits may be reclaimed. At block 312, the number of credits initially allocated to a first source node of source nodes 120 via the inactivated accounting channel may be compared to the number of the remaining credits transmitted from the inactivated accounting channel to destination accounting buffer 114. The difference between the initial number of credits allocated to the number of remaining credits transmitted may equal the number of lost credits. At block 314, to reclaim lost credits, the transmitted remaining credits may be added to credit pool 116 of destination accounting buffer 114 in addition to the number of lost credits determined from the comparison at block 312. Credits within credit pool 116 may be freely assignable by destination accounting buffer 114 to other source nodes of source nodes 120.

In an example, the process of switching active and inactive channels may be periodic and may occur after a predetermined event or after a predetermined period of time. At block 316, the system waits for the predetermined event to trigger or the predetermined period of time. The triggering of the predetermined event or period of time is followed by a return to block 302. The predetermined event and/or predetermined period of time may be a number of credits transmitted or received by destination accounting buffer 114, a predetermined period of time for which credits have not been added to the credit pool of destination accounting buffer 114, a predetermined time since credits were initially allocated by destination node 110 to a source node of source nodes 120, a predetermined time since first accounting channel 180 and/or second accounting channel 190 had been activated and/or inactivated, a combination thereof, and/or any other factors related to the transmission of credits between a destination node and a source node.

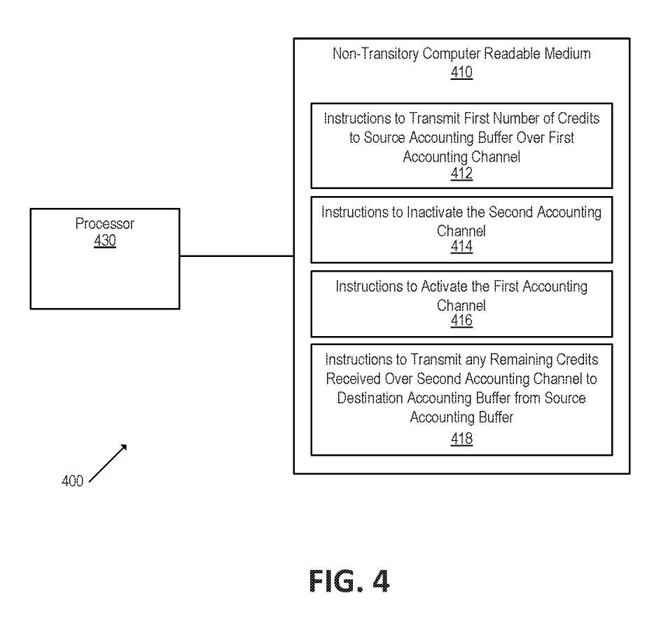

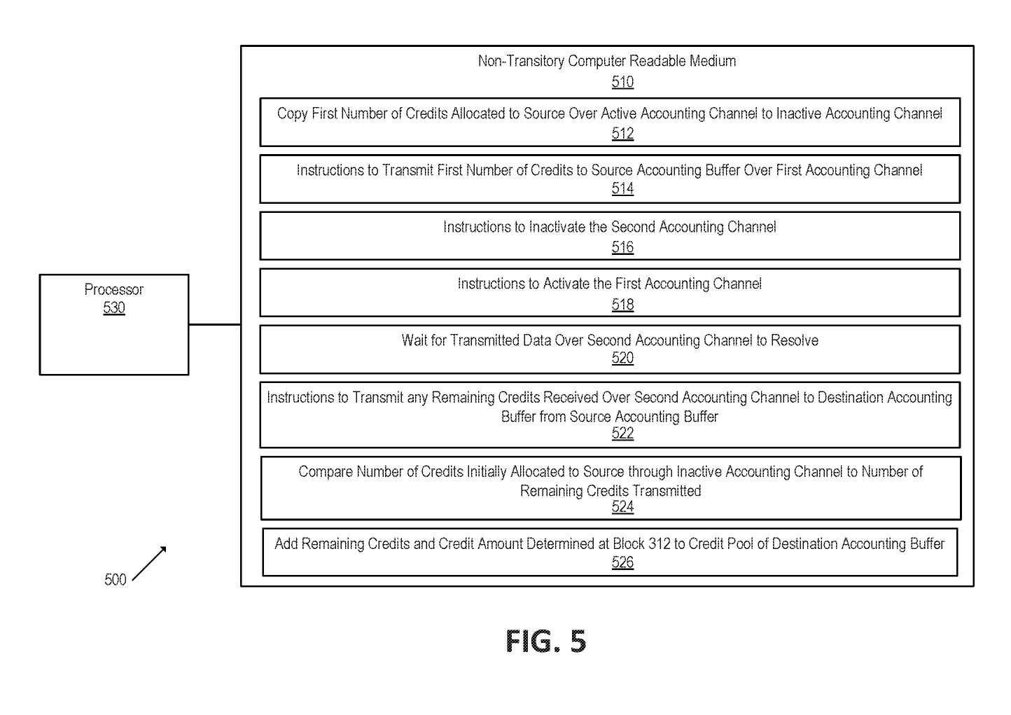

FIG. 4 and FIG. 5 are block diagrams of example non-transitory machine-readable mediums for switching the activation of accounting channels to reclaim lost credits. Non-transitory machine-readable storage medium 410 of FIG. 4 may be coupled to a processor, e.g. processor 430, and non-transitory machine-readable storage medium 510 of FIG. 5 may be coupled to a processor, e.g. processor 530, for transitioning between credit accounting channels. Non-transitory machine-readable storage medium 410 and non-transitory machine-readable storage medium 510 may include executable instructions thereon. In the foregoing discussion, system 100 was described as having an integrated circuit 130 including logic 132-138. Instructions 412-418 may carry out the steps of logic 132-138 as described above.

Non-transitory machine-readable storage medium 410 (or non-transitory machine-readable storage medium 510) may be implemented in a single device or distributed across devices. Likewise, processor 430 (or processor 530) may represent any number of physical processors capable of executing instructions stored by non-transitory machine-readable storage medium 410 (or non-transitory machine-readable storage medium 510). Further, non-transitory machine-readable storage medium 410 (or non-transitory machine-readable storage medium 510) may be fully or partially integrated in the same device as processor 430 (or processor 530), or it may be separate but accessible to that device.

In one example, the instructions may be part of an installation package that when installed can be executed by processor 410 (or processor 510) to transition between accounting channels. In this case, non-transitory machine-readable storage medium 410 (or non-transitory machine-readable storage medium 510) may be a portable medium such as a floppy disk, CD, DVD, or flash drive or a memory maintained by a server from which the installation package can be downloaded and installed. In another example, the program instructions may be part of an application or applications already installed. Here, non-transitory machine-readable storage medium 410 (or non-transitory machine-readable storage medium 510) may include a hard disk, optical disk, tapes, solid state drives, RAM, ROM, EEPROM, or the like.

Processor 430 or 530 may be a central processing unit (CPU), graphics processing unit (GPU), microprocessor, and/or other hardware device suitable for retrieval and execution of instructions stored in non-transitory machine-readable storage medium 410 (or non-transitory computer readable storage medium 510). Processor 430 may fetch, decode, and execute program instructions 412-418, and/or other instructions. Similarly, processor 530 may fetch, decode, and execute program instructions 512-526. As an alternative or in addition to retrieving and executing instructions, processor 430 may include at least one electronic circuit comprising a number of electronic components for performing the functionality of instructions 412-418, and/or other instructions. Similarly, processor 530 may include at least one electronic circuit comprising a number of electronic components for performing the functionality of instructions 512-526, and/or other instructions.

Turning to FIG. 5, non-transitory machine-readable medium 510 may include instructions 512, that, when executed, may cause processor 530 to copy a first number of credits allocated to a source node over an active accounting channel to an inactive accounting channel. Instructions 514, when executed, may cause processor 530 to transmit a first number of credits to a source accounting buffer of the source node over the inactive accounting channel. Thus, an equal number of credits may be allocated over the active accounting channel and the inactive accounting channel.

Instructions 516, when executed, may cause processor 530 to inactivate the active accounting channel, and instructions 518, when executed, may cause processor 530 to activate the inactive accounting channel. In an example, the active status of the channels may be switched in response to an event, such as a received message, and/or a receipt of credits over the inactive accounting channel. Accordingly, the active status of each accounting channel may be switched.

Instructions 520, when executed, may cause a wait time between the execution of instructions 518 and the execution of instructions 522. This wait time may enable transmitted data over the inactivated accounting channel to resolve. Instructions 522 may be executed thereafter, and may cause processor to transmit any remaining credits received over the inactivated accounting channel from the source accounting buffer to a destination accounting buffer of a destination node.

Instructions 524, when executed, may cause processor 530 to compare the number of credits initially allocated to the source node via the inactivated accounting channel to the number of the remaining credits transmitted from the inactivated accounting channel to the destination accounting buffer. The difference between the initial number of credits allocated to the number of remaining credits transmitted may equal the number of lost credits. To reclaim lost credits, instructions 526, when executed, may cause processor 530 to add the remaining credits to a credit pool of the destination accounting buffer in addition to the determined number of lost credits. Credits within the credit pool may be freely assignable by the destination accounting buffer to other source nodes.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method comprising:
transmitting a first number of credits to a source accounting buffer over a first accounting channel that is inactive, wherein each credit defines an amount of data available to a source to transmit to a destination memory, the source accounting buffer to track credits available to the source and a destination accounting buffer to track credits available to the destination memory;
inactivating a second accounting channel for transmitting credits between the source accounting buffer and the destination accounting buffer;
activating the first accounting channel for the transmission of credits between the source accounting buffer and the destination accounting buffer; and
transmitting any remaining credits received via the second accounting channel from the source accounting buffer to the destination accounting buffer.

2. The method of claim 1, further comprising adding the remaining credits transmitted from the source accounting buffer to a credit pool of the destination accounting buffer.

3. The method of claim 2, further comprising comparing a number of credits initially allocated to the source through the second accounting channel to a number of the remaining credits transmitted, and adding a number of credits to the credit pool equal to the difference between the number of credits initially allocated to the source over the second accounting channel and the number of remaining credits transmitted.

4. The method of claim 1, further comprising waiting a predetermined period of time for transmitted data over the inactivated second accounting channel to resolve before transmitting the remaining credits.

5. The method of claim 4, wherein the predetermined period of time is dynamically adjusted based on at least one of a fabric and a fabric congestion.

6. The method of claim 1, further comprising copying the first number of credits allocated to the source over the second active accounting channel to the first inactive accounting channel.

7. The method of claim 1, further comprising:
after a predetermined time has elapsed,
transmitting to the source accounting buffer over the second inactive accounting channel, a second number of credits;
inactivating the first active accounting channel;
activating the second accounting channel; and
transmitting any remaining credits of the first accounting channel from the source accounting buffer to the destination accounting buffer.

8. A networking system comprising:
a destination node including a memory space for received data and a destination accounting buffer to track credits available for transmission;
a source node including a source accounting buffer to track credits available to the source node for transmitting data to the destination node;
a first accounting channel for, when active, transmitting credits between the source accounting buffer and the destination accounting buffer;
a second accounting channel for, when active, transmitting credits between the source accounting buffer and the destination accounting buffer; and
an integrated circuit configured to:
transmit a first number of credits to the source accounting buffer over the first accounting channel;
inactivate the second accounting channel;
activate the first accounting channel; and
transmit any remaining credits received over the second accounting channel to the destination accounting buffer from the source accounting buffer.

9. The networking system of claim 8, wherein each credit defines a unit size of data.

10. The networking system of claim 8, wherein the integrated circuit is configured to add the remaining credits transmitted from the source accounting buffer to a credit pool of the destination accounting buffer.

11. The networking system of claim 10, wherein the integrated circuit is configured to compare a number of credits initially allocated to the source node via the second accounting channel, to a number of the remaining credits transmitted, and add a number of credits to the credit pool equal to the difference between the number of credits initially allocated to the source node over the second accounting channel and the number of remaining credits transmitted.

12. The networking system of claim 8, wherein the integrated circuit is configured to wait a predetermined period of time for transmitted data over the inactivated second accounting channel to settle before transmitting the remaining credits.

13. The networking system of claim 8, wherein the integrated circuit is configured to:
after a predetermined time has elapsed since activating the first accounting channel,
transmit to the source accounting buffer over the second accounting channel, a second number of credits;
inactivate the first active accounting channel;
activate the second accounting channel; and
transmit any remaining credits of the first accounting channel from the source accounting buffer to the destination accounting buffer.

14. The networking system of claim 8, wherein the integrated circuit is configured to copy the first number of credits allocated to the source node over the second accounting channel to the first accounting channel.

15. A non-transitory computer readable medium comprising instructions executable by a processor, the computer readable storage medium comprising:
instructions to cause the processor to transmit a first number of credits to a source accounting buffer over a first inactive accounting channel, the source accounting buffer to track credits available to a source and a destination accounting buffer to track credits available to a destination memory;
instructions to cause the processor to inactivate a second active accounting channel for transmitting credits between the source accounting buffer and the accounting destination;
instructions to cause the processor to activate the first accounting channel for the transmission of credits between the source accounting buffer and the accounting destination; and
instructions to cause the processor to transmit any remaining credits received from the second accounting channel from the source accounting buffer to the destination accounting buffer.

16. The non-transitory computer readable medium of claim 15, further comprising adding the remaining credits transmitted from the source accounting buffer to a credit pool of the destination accounting buffer.

17. The non-transitory computer readable medium of claim 15, further comprising comparing a number of credits initially allocated to the source through the second accounting channel to a number of the remaining credits transmitted, and adding a number of credits to a credit pool equal to the difference between the number of credits initially allocated to the source over the second accounting channel and the number of remaining credits transmitted.

18. The non-transitory computer readable medium of claim 15, further comprising waiting a predetermined period of time for transmitted data over the inactivated second accounting channel to resolve before transmitting the remaining credits.

19. The non-transitory computer readable medium of claim 15, further comprising copying the first number of credits allocated to the source over the second active accounting channel to the first inactive accounting channel.

20. The non-transitory computer readable medium of claim 15, wherein each credit defines a unit size of data.
